(19) United States
(12) Patent Application Publication
(10) Pub. No.: US 2024/0284814 A1
(43) Pub. Date: Aug. 29, 2024

(54) AGRICULTURAL MACHINE COMPRISING A SUCKER-REMOVING DEVICE ADAPTED TO REMOVE SUCKERS FROM A VEGETABLE PLANT

(71) Applicant: Spolgreen SRL, Cuneo (CN) (IT)

(72) Inventor: Livio Bongiovanni, Cuneo (IT)

(21) Appl. No.: 18/569,966

(22) PCT Filed: Jun. 22, 2022
(86) PCT No.: PCT/IB2022/055773

§ 371 Date: Dec. 13, 2023

(30) Foreign Application Priority Data
Jun. 26, 2021 (IT) 102021000016487

(51) Int. Cl. A01B 39/08; A01G 17/02

(52) U.S. Cl. CPC A01B 39/085; A01G 17/023

(57) ABSTRACT

An agricultural machine including a vegetable sucker-removing device includes: an arm extending from the agricultural machine; at least one actuator device; a support structure extending to the arm, the support structure being coupled to the arm by a main shaft extending along a vertical main axis, at least one first bearing interposed between the main shaft and the arm, and at least one second bearing interposed between the main shaft and the support structure, a cutting system including at least a first disc and a second disc, wherein the first disc is coupled to the support structure by a first shaft extending from the first disc along a first axis of rotation, and wherein the second disc is coupled to the support structure by a second shaft extending from the second disc along a second axis of rotation, a transmission system connecting the actuator device to the main shaft and the main shaft to the first shaft of the first disc and to the second shaft of the second disc.

### BACKGROUND OF THE INVENTION

### 1. The Field of the Invention

The present invention relates to an agricultural machine comprising a sucker-removing device adapted to remove suckers from a vegetable plant. The present invention also relates to an associated sucker-removing device for removing suckers from a vegetable plant.

### 2. The Relevant Technology

The present invention finds special application in the field of the activities necessary for removing suckers from a vegetable plant, in particular a hazelnut tree or a grapevine (or other plant types).

The sucker-removing device and the associated agricultural machine according to the present invention are used in order to remove suckers or sprouts that have grown near the base of the vegetable plant, without however damaging the plant.

It is known in the agricultural field that vegetable plants need to be subjected to sucker removal, pruning and polling operations.

Such operations, as is known to those skilled in the art, have been carried out manually since ancient times, and only recently some form of mechanization thereof has been attempted.

In this respect, agricultural machines are known in the art which comprise a frame to which an arm, usually a movable one, is connected. At the end of said arm there is a protection structure mounted concentrically around a shaft, to which a disc-shaped cutting device is connected, in particular said cutting device turning about said shaft. A plurality of protrusions are connected to the protection structure, which are adapted to extend the maximum diameter of the protection structure to a value exceeding the maximum diameter of the cutting device. Such protrusions are spaced apart, forming cavities the diameter of which is smaller than both the maximum diameter defined by said protrusions and the maximum diameter of the cutting device. Thus, suckers can enter such cavities and come in contact with the cutting devices, so that they can be removed by the latter; at the same time, should said protrusions come in contact with the trunk of the plant, they will prevent the cutting device from touching and damaging it.

Nevertheless, the solutions currently known in the art suffer from a few drawbacks, since suckers located on the diameter of the vegetable plant can only be reached by executing a specific movement of the arm that carries the cutting device.

It is therefore apparent that the solutions currently known in the art are very time-consuming for the user, who necessarily must, for each sucker that needs to be cut, appropriately position the arm that carries the cutting device.

Furthermore, the solutions known in the art require continual interventions by a user for properly positioning the arm and the associated cutting device; such work may become burdensome in the long run, also because of the attention that the user is compelled to pay during the sucker removal operations.

It is therefore clear that the solutions known in the art are not very efficient and cannot be properly automated, in addition to being excessively time- and resource-consuming.

### SUMMARY OF THE INVENTION

In this frame, it is the main object of the present invention to provide a sucker-removing device adapted to remove suckers from a vegetable plant, and an associated agricultural machine comprising said sucker-removing device, which are so constructed as to overcome the drawbacks of the prior art.

In particular, it is one object of the present invention to provide a sucker-removing device adapted to remove suckers from a vegetable plant, as well as an associated agricultural machine comprising said sucker-removing device, wherein said sucker-removing device is constructed in such a way as to perform an effective and fast cutting of multiple suckers located on the diameter of the vegetable plant, in particular without requiring a specific movement of the arm that carries the cutting device or system.

It is another object of the present invention to provide a sucker-removing device adapted to remove suckers from a vegetable plant, as well as an associated agricultural machine comprising said sucker-removing device, which are constructed in a manner such as to not require continual interventions by a user for properly positioning the arm and the associated cutting device, the sucker-removing device being thus so constructed as to reduce the attention required from the user during the sucker removal operations.

It is a further object of the present invention to provide a sucker-removing device adapted to remove suckers from a vegetable plant, as well as an associated agricultural machine comprising said sucker-removing device, which are constructed in a manner such as to allow the achievement of a high level of automation of the sucker removal operations and to increase the efficiency of such operations, in particular by reducing the time and resources necessary for executing such operations.

Such objects are achieved by the present invention through a sucker-removing device adapted to remove suckers from a vegetable plant, as well as an associated agricultural machine comprising said sucker-removing device, incorporating the features set out in the appended claims, which are an integral part of the present description.

### BRIEF DESCRIPTION OF THE DRAWINGS

Further objects, features and advantages of the present invention will become apparent in light of the following detailed description and the annexed drawings, which are provided herein merely by way of non-limiting explanatory example, wherein:

FIG. 1 is a perspective view of an agricultural machine comprising a sucker-removing device adapted to remove suckers from a vegetable plant according to the present invention;

FIG. 2 shows a perspective view of a first embodiment of the sucker-removing device according to the present invention;

FIGS. 3A and 3B are, respectively, a plan view and a sectional view of the sucker-removing device of FIG. 2;

FIG. 4 is a perspective view of a second embodiment of the sucker-removing device according to the present invention;

FIGS. 5A and 5B are, respectively, a plan view and a sectional view of the sucker-removing device of FIG. 4;

FIGS. 6A and 6B are, respectively, a plan view and a perspective side view of some components of the sucker-removing device according to the present invention.

### DETAILED DESCRIPTION OF THE PREFERRED EMBODIMENTS

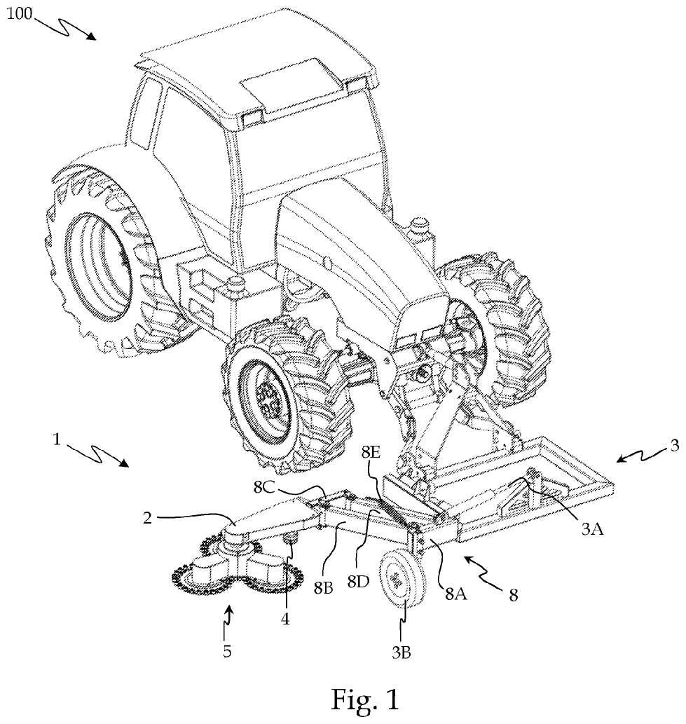

With reference to the annexed drawings, in FIG. 1 reference numeral 100 designates as a whole an agricultural machine comprising a sucker-removing device 1 according to the present invention.

In a preferred embodiment, the agricultural machine 100 is an agricultural tractor; it is however clear that the agricultural machine 100 according to the present invention may also be another type of agricultural machine, whether a self-moving one (such as, for example, an agricultural tractor or a combine harvester) or a towed one. As a consequence, reference will generally be made in the present description to an agricultural machine 100, regardless of whether it is an agricultural tractor or another type of agricultural machine.

The sucker-removing device 1 comprises an arm 2 extending substantially horizontal from the agricultural machine 100, in particular said arm 2 being adapted to operate laterally relative to the agricultural machine 100.

It should be noted that the arm 2 may be connected either directly or indirectly to the agricultural machine 100.

As far as the embodiment shown in the annexed drawings is concerned, the connection between the arm 2 and the agricultural machine 100 is an indirect one, in that such connection is provided through the interposition of a frame 3 between the arm 2 and the agricultural machine 100. In particular, said frame 3 may comprise adjuster means 3A for adjusting the height of the arm 2 from the ground; also, the frame 3 may comprise at least one wheel 3B adapted to support the arm 2 and the frame 3 on the ground. It is nevertheless apparent that the connection between the arm 2 and the agricultural machine 100 may also be a direct one, i.e., obtained by fastening the arm 2 to the agricultural machine 100 without interposing the frame 3 in between.

In the representation shown in FIG. 1, the arm 2 is connected to the front portion of the agricultural machine 100; however, said arm 2 may be connected to a rear portion of the agricultural machine 100, or laterally with respect to said agricultural machine 100 (in particular, by means of a system known in the art as “belly system”). Regardless of the portion of the agricultural machine 100 to which the arm 2 is connected, said arm 2 is anyway preferably positioned in such a way as to operate laterally relative to the agricultural machine 100 (as shown in FIG. 1), particularly so that the arm 2 can lie substantially perpendicular to the running direction of the agricultural machine 100.

The sucker-removing device 1 comprises at least one actuator device 4. In the annexed drawings, the actuator device 4 is shown to be positioned on the arm 2; however, the position of said at least one actuator device 4 may differ from the one shown in the annexed drawings.

Furthermore, in the embodiment shown in the annexed drawings the actuator device 4 consists of a hydraulic motor, in particular adapted to be connected to the hydraulic system of the agricultural machine 100; however, the actuator device 4 may consist of a motor of a different type, or may even consist of a power take-off of the agricultural machine 100 and at least one cardan shaft, in particular the power take-off and the cardan shaft being connected to an engine of the agricultural machine 100.

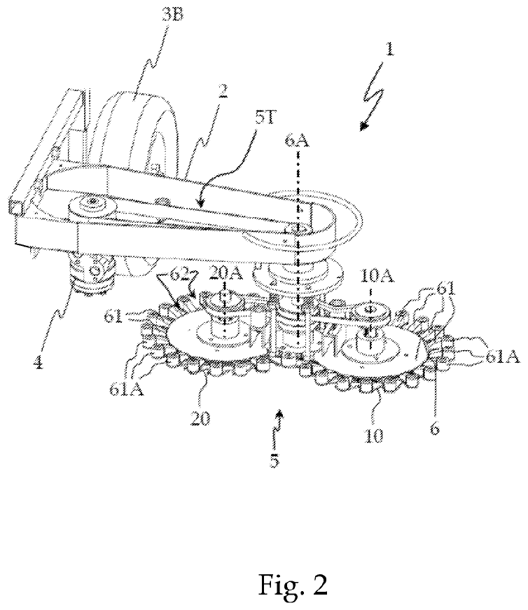

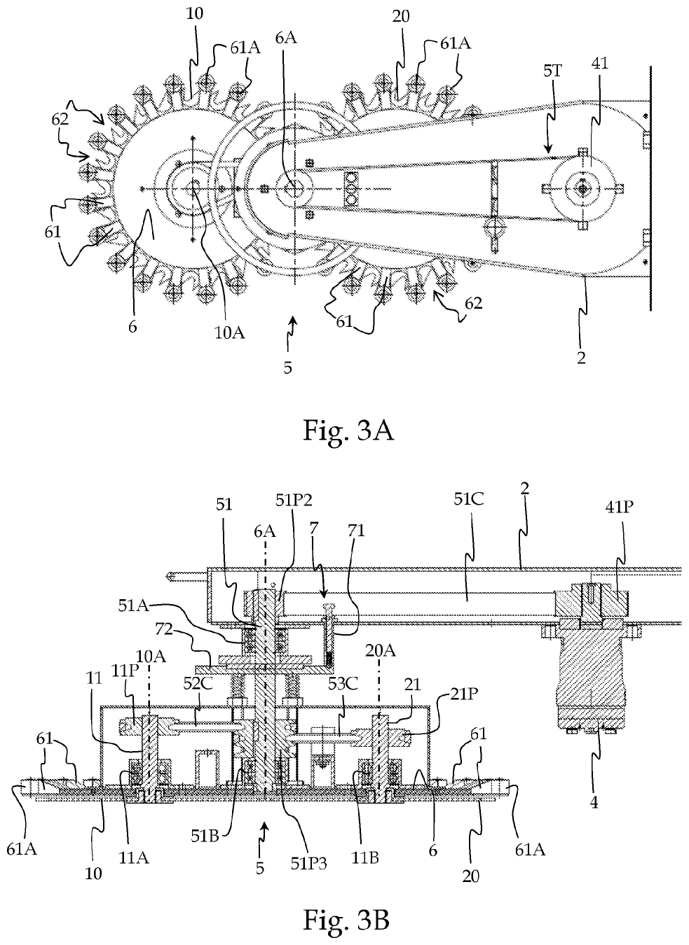

FIGS. 2 to 3B show a first embodiment of the sucker-removing device 1 according to the present invention.

In such figures one can notice that, in accordance with the present invention, the sucker-removing device 1 comprises a support structure 6 extending substantially parallel to the arm 2, wherein said support structure 6 is coupled to said arm 2 by means of a main shaft 51 extending along a substantially vertical main axis of rotation (drawn with a dashed-dotted line and identified by reference numeral 6A), at least one first bearing 51A interposed between the main shaft 51 and the arm 2, and at least one second bearing 51B interposed between the main shaft 51 and the support structure 6, such that the support structure 6 can rotate idle relative to said substantially vertical main axis of rotation 6A. The annexed figures show that the support structure 6 is coupled to the arm 2 in proximity to a free end of said arm 2, i.e., in proximity to that end of the arm 2 which is opposite to the one fixed (whether directly or through the frame 3) to the agricultural machine 100.

Moreover, in accordance with the present invention, the sucker-removing device 1 comprises a cutting system (designated as a whole by reference numeral 5) comprising at least a first disc 10 and a second disc 20, wherein the first disc 10 is coupled to said support structure 6 by means of a first shaft 11 extending substantially perpendicular from the first disc 10 along a first axis of rotation 10A, and wherein the second disc 20 is coupled to said support structure 6 by means of a second shaft 21 extending substantially perpendicular from the second disc 20 along a second axis of rotation 20A, in particular said cutting system 5 comprising at least one third bearing 11A interposed between the first shaft 11 and the support structure 6 and at least one fourth bearing 21A interposed between the second shaft 21 and said support structure 6.

The sucker-removing device 1 according to the present invention further comprises a transmission system (designated as a whole by reference numeral 5T) connecting the actuator device 4 to the main shaft 51 and connecting said main shaft 51 to the first shaft 11 of the first disc 10 and to the second shaft 21 of the second disc 20, wherein the first disc 10 and the second disc 20 are set in motion by said actuator device 4 and by said transmission system 5T so as to rotate about said first axis of rotation 10A and, respectively, about said second axis of rotation 20A, which are substantially parallel to said main axis of rotation 6A, for the purpose of removing suckers from a vegetable plant.

It should be noted that the transmission system 5T may be implemented in many different, but equivalent, ways.

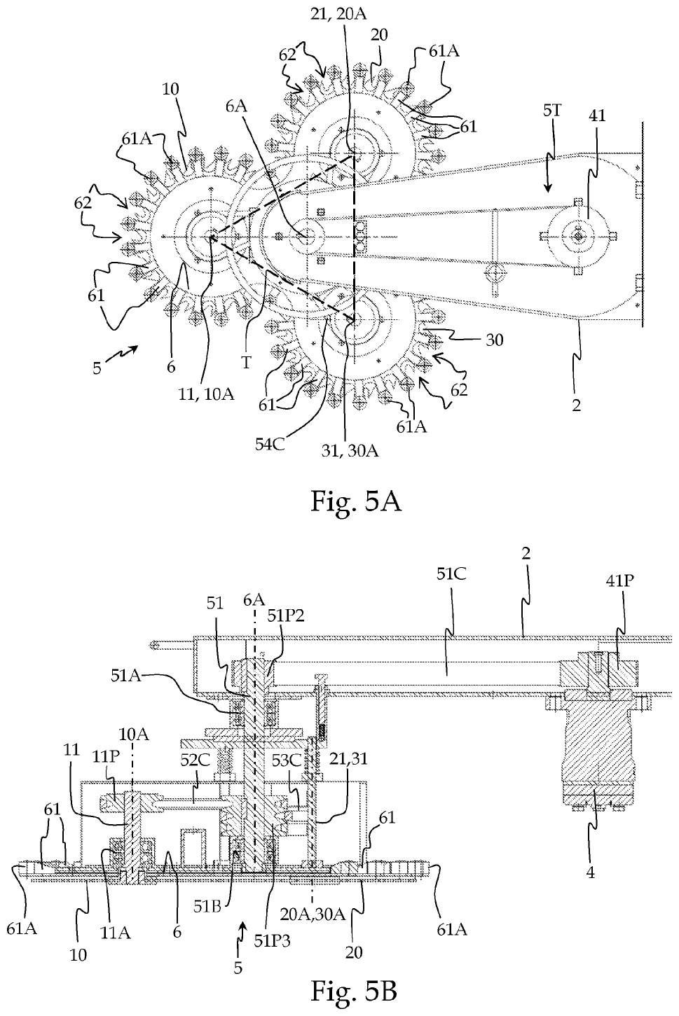

For example, in the annexed drawings said transmission system 5T is depicted as a set of belt-type transmission systems, in particular comprising (see FIGS. 3B and 5B):
a first belt 51C adapted to connect the actuator device 4 to the main shaft 51, in particular said first belt 51C connecting a first pulley 41P of the actuator device 4 to a second pulley 51P2 of the main shaft 51;
a second belt 52C adapted to connect the main shaft 51 to the first shaft 11 of the first disc 10, in particular said second belt 52C connecting a third pulley 51P3 of said main shaft 51 to a fourth pulley 11P of the first shaft 11;
a third belt 53C adapted to connect said main shaft 51 to the second shaft 21 of the second disc 20, in particular said third pulley 53C connecting the third pulley 51P3 of the main shaft 51 to a fifth pulley 21P of the second shaft 21.

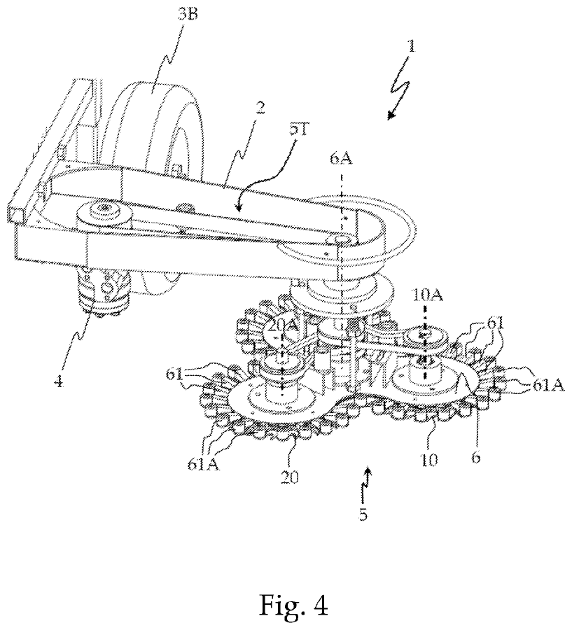

In this context, preferably the first pulley 41P of the actuator device 4 has a larger diameter than the second pulley 51P2 of the main shaft 51, resulting in a multiplication ratio that increases the number of revolutions of the main shaft 51 in comparison with the number of revolutions of the actuator device 4; also, the third pulley 51P3 of the main shaft 51 is so constructed as to comprise a number of grooves that matches the number of discs 10, 20, 30 with which the sucker-removing device 1 is equipped (i.e., the third pulley 51P3 comprises two grooves in the first embodiment shown in FIGS. 2 to 3B and three grooves in the second embodiment shown in FIGS. 4 to 5B, said second embodiment being described later on in the present disclosure).

It is nevertheless apparent that the transmission system 5T may also be constructed otherwise, e.g., by means of a set of chain transmissions, or as a gear system, or using other equivalent motion transmission means.

As can be observed in the annexed drawings, in a preferred embodiment the first disc 10 and the second disc 20 are so constructed as to have a cutting perimeter; as a result, in said preferred embodiment the first disc 10 and the second disc 20 are themselves cutting elements, as shown in the annexed figures, and particularly in FIG. 3A.

Alternatively, the first disc 10 and the second disc 20 may be so constructed as to have teeth for moving a cutting element consisting of a chain, e.g., similar to that of a chain saw; in this alternative solution, therefore, the chain is the cutting element.

In accordance with a further alternative, the first disc 10 and the second disc 20 may be so constructed as to constitute elements for moving a cutting element consisting of a trimmer wire, e.g., made of plastic material.

The choice among the different cutting elements described above may depend on the characteristics of the vegetable plant, e.g., its hardness or fibrousness.

In all of said embodiments, the first disc 10 and the second disc 20 are preferably so constructed as to have substantially the same diameter. In this regard, said discs 10, 20 are preferably so constructed as to have a diameter of approximately 250 mm; nevertheless, it is apparent that the diameter of the discs 10, 20 may also be greater or smaller, and said discs 10, 20 may also have different diameters.

Furthermore, the first disc 10 and the second disc 20 face towards the support structure 6, in particular towards a lower portion (or an underside) of said support structure 6, and are positioned at a given distance from said support structure 6; preferably, the first disc 10 and the second disc 20 are positioned at substantially the same distance from the support structure 6, and are supported by said support structure 6 in such a way that they are coplanar to each other. In this respect, it should be noted that the lower portion (or the underside) of the support structure 6 is that surface which, in an operating condition of the sucker-removing device 1 according to the present invention, faces towards the ground.

In this frame, both the first shaft 11 (and hence the first axis of rotation 10A) of the first disc 10 and the second shaft 21 (and hence the second axis of rotation 20A) of the second disc 20 are substantially vertical, i.e., substantially perpendicular to the development of the arm 2 and/or of the support structure 6, and substantially parallel to the main shaft 51 (and hence to the main axis of rotation 6A).

Preferably, in the first embodiment the support structure 6 is, in a plan view (as shown in FIG. 3A), shaped as two circumferences in contact with each other (i.e., substantially like a figure of eight), or substantially as an ellipse, in particular flattened on its major axis and/or with recesses on the perimeter portion facing towards the major axis of said ellipse.

In this context, the first shaft 11 (with its first axis of rotation 10A) of the first disc 10 and the second shaft 21 (with its second axis of rotation 20A) of the second disc 20 are positioned substantially at the centres of said two circumferences (i.e., substantially at the focal points of the ellipse).

Moreover, the main shaft 51 (with its main axis of rotation 6A) is substantially equidistant from said first shaft 11 (with its first axis of rotation 10A) and second shaft 21 (with its second axis of rotation 20A). In substance, the main shaft 51 and the main axis of rotation 6A extend perpendicular to a median point of a straight line connecting the first shaft 11 and the first axis of rotation 10A to the second shaft 21 and the second axis of rotation 20A. In this regard, it should be noted that the half-lines that join the main shaft 51 (and the main axis of rotation 6A) to the shafts 11, 21 (and the axes of rotation 10A, 20A) of the discs 10, 20 are positioned at substantially 180° away from each other.

In accordance with the present invention, the support structure 6 comprises a plurality of protrusions 61 spaced apart along an outer perimeter of said support structure 6 so as to define a plurality of recesses 62 between said protrusions 61, wherein each recess 62 is adapted to receive a sucker to be cut by said discs 10, 20.

In particular, the assembly including said support structure 6 and each protrusion 61 extends along at least one plane perpendicular to each one of said first axis of rotation 10A and second axis of rotation 20A (or, respectively, a plane perpendicular to the first shaft 11 and second shaft 21) by a quantity greater than the extension along the same perpendicular plane of each one of said first disc 10 and second disc 20. Moreover, each recess 62 comprises a bottom which is distant from, respectively, the first axis of rotation 10A and the second axis of rotation 20A (or from the respective first shaft 11 and second shaft 21) by a quantity smaller than the extension of the respective first disc 10 and second disc 20 along said perpendicular plane, so that the first disc 10 and/or the second disc 20 can come in contact (whether directly or through the interposition of a different cutting element, e.g., a chain or a trimmer wire) with each sucker that enters said recesses 62 and cut it.

Preferably, the bottom of each recess 62 is defined by the support structure 6 itself, and the depth of each recess 62 is defined by the extension of each protrusion 61 from the outer perimeter of the support structure 6.

In addition, each protrusion 61 comprises a striker element 61A positioned in proximity to a distal end of the protrusion 61 (i.e., in proximity to that end of the protrusion 61 which is opposite to the one that joins the support structure 6) and adapted to mitigate a possible impact of the sucker-removing device 1 against a plant; in order to improve the ability of the striker elements 61A to damp said impact, they may be made of a material suitable for such purpose, e.g., elastic material.

Furthermore, each striker element 61A is preferably associated with the respective protrusion 61 by means of a respective pin, in such a way that it can rotate idle relative to said protrusion 61, in particular such idle rotation of each striker element 61A occurring about a respective pin lying along an axis substantially parallel to the main axis of rotation 6A; in addition to the above-mentioned function of damping possible impacts against a plant, the idle rotation of the striker elements 61A also facilitates the entrance of the suckers into the recesses 62.

The peculiar provisions of the present invention make it possible to provide a sucker-removing device 1 so constructed as to be able to cut, in an effective and fast manner, multiple suckers located on the diameter of the vegetable plant, in particular without requiring any specific movement of the arm 2 that carries the cutting system 5.

In fact, the provision of the support structure 6 coupled to said arm 2 in such a way as to rotate idle relative to a substantially vertical main axis of rotation 6A, with the discs 10, 20 carried by said support structure 6, permits increasing the area where suckers are removed around said vegetable plant, thus speeding up the sucker removal operations.

In this respect, it must be pointed out that, in fact, the idle rotation of the support structure 6 allows the discs 10, 20, which are carried by said support structure 6, to remove at least those suckers which are located in a first half of said vegetable plant by executing a first pass with the arm 2 and the associated cutting system 5 on a first side of the vegetable plant; in order to remove the suckers located in the remaining half of the vegetable plant, it will be sufficient to execute a second pass with the arm 2 and the associated cutting system 5 on a second side of the vegetable plant.

It should also be noted that the positioning of each disc 10, 20 relative to the vegetable plant is dictated by the contact between the plant and the support structure 6 and by the idle rotation of the support structure 6, in particular, said idle rotation being in turn induced and guided by such contact between the plant and the support structure 6.

It is therefore clear that the sucker-removing device 1 according to the present invention is constructed in such a way that it does not require continual interventions by a user in order to properly position the arm 2 and the associated cutting system 5; as a result, the sucker-removing device 1 according to the present invention is so constructed as to reduce the attention required from the user during the sucker removal operations.

The sucker-removing device 1 according to the present invention makes it possible, therefore, to attain a high level of automation of the sucker removal operations and to increase the efficiency of such operations, in particular by reducing the time and resources necessary for the execution of such operations.

The provision of the protrusions 61 and the associated striker elements 61A facilitates said idle rotation of the support structure 6, in that such rotation occurs also as a result of the contact between the protrusions 61, possibly provided with associated striker elements 61A, and the vegetable plant. In addition to this, the protrusions 61 and/or the associated striker elements 61A avoid damage to the vegetable plant by preventing it from touching the discs 10, 20, 30, and also mitigate possible impacts of the sucker-removing device 1 against said plant from which suckers have to be removed; moreover, said striker elements 61A turn out to be particularly effective in facilitating the entrance of the suckers into the recesses 62.

In accordance with a preferred embodiment, the sucker-removing device 1 according to the present invention comprises a retaining device (designated as a whole by reference numeral 7 in FIGS. 3B and 5B), in particular interposed between the arm 2 and the support structure 6, adapted to stop or counter the idle rotation of the support structure 6 when it is not in contact with the vegetable plant, and to release the idle rotation of said support structure 6 when it is in contact (typically through the striker elements 61A) with the vegetable plant.

In accordance with a preferred embodiment, said retaining device 7 consists of a ball-type retainer, i.e., a system comprising a hollow body 71 (preferably cylindrical in shape) integrally connected to the arm 2 and housing a spring, on top of which there is a ball adapted to be received into at least one cavity provided on the support structure 6 or (as shown in the annexed drawings) on a plate 72 integrally connected to said support structure 6.

In particular, in the first embodiment shown in FIGS. 2 to 3B, said plate 72 comprises a pair of cavities for stopping the idle rotation of the support structure 6, said cavities being located on the plate 72 so as to lie on a straight line substantially parallel to (or substantially coinciding with) a straight line joining the axes of rotation 10A, 10B of the discs 10, 20 to a point where the arm 2 is attached to the agricultural machine 100. In substance, in the first embodiment the cavities are positioned at six o'clock and at twelve o'clock (i.e., spaced apart by 180°) relative to the development of the arm 2, wherein such development can also be defined by a straight line that connects the main axis of rotation 6A to a point where the arm 2 is attached to the agricultural machine 100.

It is nevertheless apparent that the retaining device 7 according to the present invention may also be constructed by means of other elements equivalent to those described herein. By way of example, the retaining device 7 may be constructed by means of friction elements (not shown in the annexed drawings, but which may comprise brake linings) positioned on the arm 2 and on the support structure 6, respectively, and in contact with each other, wherein said friction elements are configured in such a way as to exert resistance against the idle rotation of the support structure 6 when it is not in contact with the vegetable plant, and in such a way as to release the idle rotation of said support structure 6 when it is in contact (typically through the striker elements 61A) with the vegetable plant; as an alternative, the retaining device 7 may be constructed as a magnetic system (wherein the brake linings are substituted by magnets having opposite polarities and facing each other, respectively positioned on the arm 2 and on the support structure 6, wherein said magnets are adapted to exert resistance against the idle rotation of the support structure 6 when it is not in contact with the vegetable plant), or by means of other elements or systems known in the art.

In accordance with a preferred embodiment, the sucker-removing device 1 according to the present invention comprises a shock-absorbing device (designated as a whole by reference numeral 8 in FIG. 1) interposed between the arm 2 and the agricultural machine 100 and configured to allow the arm 2 (and hence the support structure 6 and the discs 10, 20) to move along a horizontal plane (i.e., a plane parallel to the one in which the support structure 6 and the arm 2 lie) when the support structure 6 is in contact with the vegetable plant.

Preferably, as shown in FIG. 1, said shock-absorbing device 8 consists of a mechanism that comprises:
four rods 8A, 8B, 8C, 8D parallel to each other in pairs and hinged to each other in pairs (in particular, hinged in proximity to their respective ends), wherein a first rod 8A of said four rods 8A, 8B, 8C, 8D is fixed (whether directly or through said frame 3) to the agricultural machine 100, and wherein the arm 2 is fixed to a rod 8B, 8C, 8D other than said first rod 8A. For example, in FIG. 1 the arm 2 is fixed to a third rod 8C, but it is clear that said arm 2 may be fixed to a second rod 8B or a fourth rod 8D;
at least one return element 8E which comprises a first portion or end fastened to a fixed point of the agricultural machine 100 and a second portion or end fastened to a rod 8B, 8C, 8D other than said first rod 8A.

Preferably, said at least one return element 8E is an elastic element, in particular a coil spring. Moreover, as can be seen in FIG. 1, the fixed point of the agricultural machine 100 (to which the first portion or end of the return element 8E is fastened) may consist of the first rod 8A (which, as already explained, is in turn fastened to the agricultural machine 100, whether directly or through the frame 3); it is however clear that said fixed point of the agricultural machine 100 may also consist of other elements, e.g., the frame 3 or another element of the agricultural machine 100. Furthermore, in FIG. 1 the second portion or end of the return element 8E is fastened to the fourth rod 8D; it is however clear that said second portion or end of the return element 8E may be fastened to a second rod 8B or a third rod 8C.

It is thus apparent that the shock-absorbing device 8 according to the present invention is shaped substantially as an articulated parallelogram (or an articulated rhombus), wherein the rods 8A, 8B, 8C, 8D are the sides of said articulated parallelogram (or articulated rhombus); in this context, a contact between the support structure 6 and the vegetable plant will cause a deformation of the articulated parallelogram (or rhombus), resulting in the arm 2 moving along a horizontal plane, while said at least one return element 8E is an element configured to cause the articulated parallelogram (or rhombus) to return to its original conformation when the support structure 6 is no longer in contact with the vegetable plant.

It is apparent that, if the sucker-removing device 1 is connected to the agricultural machine 100 through the interposition of a frame 3 between the arm 2 and the agricultural machine 100, said shock-absorbing device 8 may be comprised in said frame 3 and/or interposed between the arm 2 and the frame 3.

It is therefore evident that the positioning of the arm 2 (and hence of the support structure 6 and discs 10, 20 carried by the support structure 6) relative to the plant is dictated by the shock-absorbing device 8, which is configured in a manner such that the entire arm 2 can move horizontally whenever the plant comes in contact with the support structure 6; as a consequence, the provision of the shock-absorbing device 8 prevents the plant from being damaged upon touching the support structure 6; in fact, the shock-absorbing device 8 avoids the risk of jamming between the vegetable plant and the support structure 6, which jamming would otherwise inevitably damage the vegetable plant.

FIGS. 4 to 5B show a second embodiment of the sucker-removing device 1 according to the present invention.

The following will describe those features of the second embodiment which differ from those already described with reference to the first embodiment of the sucker-removing device 1 according to the present invention.

In accordance with the second embodiment, the cutting system 5 of the sucker-removing device 1 comprises a third disc 30 coupled to said support structure 6 by means of a third shaft 31 extending substantially perpendicular from the third disc 30 along a third axis of rotation 30A which is substantially parallel to the main axis of rotation 6A, wherein the third shaft 31 and the third disc 30 are set in motion by said actuator device 4 and by said transmission system 5T so as to rotate about said third axis of rotation 30A.

In particular, the transmission system 5T comprises, therefore, a fourth belt 54C adapted to connect the main shaft 51 to the third shaft 31 of the third disc 30, in particular said fourth belt 54C connecting the third pulley 51P3 of the main shaft 51 to a sixth pulley (not shown in the annexed drawings) of the third shaft 31; it should be noted that, in this case as well, the transmission system 5T may be constructed differently by using equivalent motion transmission means.

Also in this case, the third disc 30 may be so constructed as to have a cutting perimeter, thus acting as a cutting element (as shown in the annexed drawings, and particularly in FIG. 5A), or it may be so constructed as to have teeth for moving (in co-operation with the first disc 10 and the second disc 20) a cutting element consisting of a chain, or it may be so constructed as to constitute an element for moving a cutting element consisting of a trimmer wire, e.g., made of plastic material. Moreover, the third disc 30 may have substantially the same diameter as the first disc 10 and the second disc 20, in particular approximately 250 mm; alternatively, the diameter of the third disc 30 may be different from that of the first disc 10 and/or second disc 20.

Furthermore, the third disc 30 also faces towards the support structure 6, in particular towards a lower portion (or an underside) of said support structure 6, and is positioned at a given distance from said support structure 6. In this regard, it should be noted that, preferably, the first disc 10, the second disc 20 and the third disc 30 are all positioned at the same distance from the support structure 6; also, the first disc 10, the second disc 20 and the third disc 30 are carried by said support structure 6 in such a way that they are substantially coplanar with one another.

Preferably, in the second embodiment the support structure 6 has, in a plan view (as shown in FIG. 5A), a perimeter substantially shaped as three circumferences in contact with one another, wherein the first shaft 11 (with its first axis of rotation 10A), the second shaft 21 (with its second axis of rotation 20A) and the third shaft 31 (with its third axis of rotation 30A) are positioned substantially at the centres of said three mutually contacting circumferences; in this context, said first shaft 11 (with the first axis of rotation 10A), second shaft 21 (with the second axis of rotation 20A) and third shaft 31 (with the third axis of rotation 30A) lie, in a plan view of the support structure 6, at the vertices of a triangle (designated by reference T in FIG. 5A), in particular an equilateral triangle.

Moreover, the main shaft 51 (or the main axis of rotation 6A) is substantially equidistant from said first shaft 11 (with the first axis of rotation 10A), second shaft 21 (with the second axis of rotation 20A) and third shaft 31 (with the third axis of rotation 30A); in substance, the main shaft 51 and its main axis of rotation 6A lie substantially at the centre of the support structure 6.

The second embodiment turns out to be particularly effective in enlarging the area where suckers can be removed around said vegetable plant; in fact, the idle rotation of the support structure 6 and the presence of three discs 10, 20, 30 widen the area of the vegetable plant that comes in contact with the cutting system 5, thus speeding up the sucker removal operations even more.

In the second embodiment the positioning of each disc 10, 20, 30 relative to the vegetable plant is also dictated by the contact between the vegetable plant and the support structure 6 and by the idle rotation of the support structure 6, wherein said idle rotation is in turn induced and guided by such contact between the plant and the support structure 6. Moreover, in the second embodiment the positioning of the arm 2 (and also of the discs 10, 20, 30 carried by the support structure 6 and by the arm 2) relative to the vegetable plant is also dictated by the shock-absorbing device 8, which is configured in a manner such that the entire arm 2 can move horizontally (i.e., along a horizontal plane parallel to the one in which the support structure 6 and the arm 2 lie) when contact occurs between the plant and the support structure 6. As a consequence, in the second embodiment the shock-absorbing device 8 also makes it possible to prevent the vegetable plant from suffering damage upon touching the support structure 6.

As far as the retaining device 7 is concerned, in the second embodiment shown in FIGS. 4 to 5B the support structure 6 (or the plate 72 integral with the support structure 6) comprises three cavities for stopping (in co-operation with the hollow body 71 positioned on the arm 2) the idle rotation of said support structure 6, wherein said cavities are positioned on the plate 72 at four o'clock, eight o'clock and twelve o'clock, respectively (i.e., mutually spaced apart by 120°) relative to the development of the arm 2 (in this case as well, the development of the arm 2 can be defined by a straight line connecting the main axis of rotation 6A to a point where the arm 2 is attached to the agricultural machine 100). With reference to the second embodiment, it should be noted that also the straight lines that join the first shaft 11 (and the main axis of rotation 6A) to the shafts 11, 21, 31 (and the axes of rotations 10A, 20A, 30A) of the discs 10, 20, 30 are mutually positioned at substantially 120°.

It is nevertheless apparent that also the retaining device 7 of the second embodiment may be constructed differently than shown in the annexed drawings, since it may, for example, be implemented as a magnetic system, or by using other elements or systems known in the art.

In accordance with a preferred embodiment of the sucker-removing device 1 according to the present invention, the protrusions 61 may be so constructed as to be removably connected to the support structure 6. The type, shape, number and size of the protrusions 61 can thus be changed as required, making it also possible to vary the size (in particular, the width) of each recess 62; by way of example, the possibility of removing the protrusions 61 results in the possibility of changing the number and relative position of said protrusions 61, and hence of adapting the size of each recess 62 to the size of the suckers to be removed and of the vegetable plant without it being necessary to replace the whole cutting system 5.

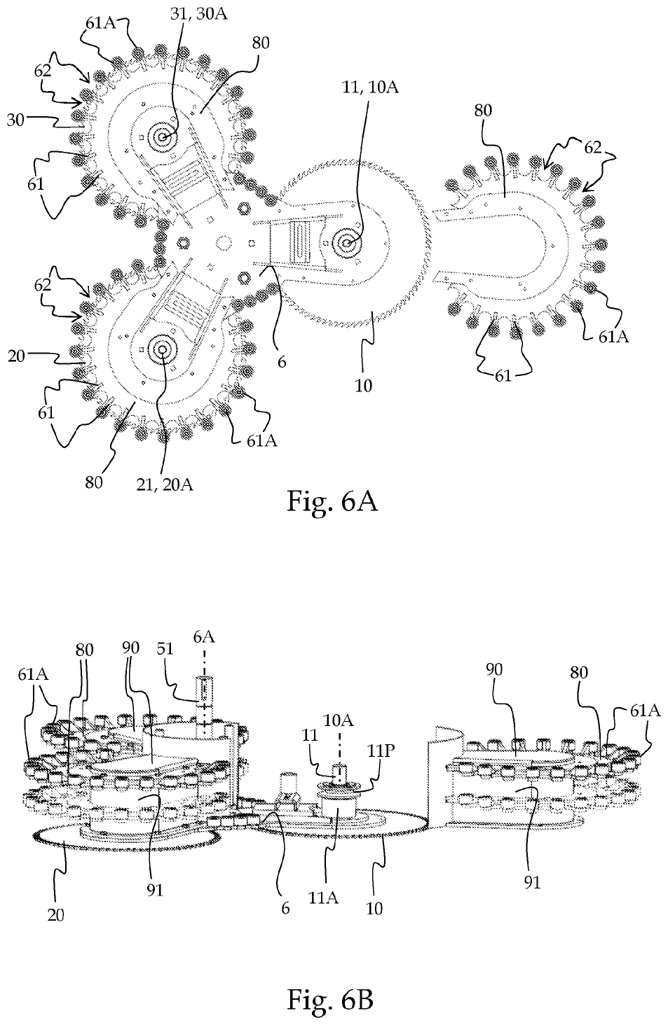

In this regard, in FIG. 6A one can see that the sucker-removing device 1 according to the present invention comprises a plurality of coupling elements 80 removably fixed to the support structure 6, wherein the number of coupling elements 80 matches the number of discs 10, 20, 30 coupled to the support structure 6 (i.e.: two coupling elements 80 in the first embodiment shown in FIGS. 2 to 3B and comprising two discs 10, 20; three coupling elements 80 in the second embodiment shown in FIGS. 4 to 5B and comprising three discs 10, 20, 30), and wherein each coupling element 80 comprises a plurality of protrusions 61 and respective recesses 62 on its outer edge.

In the embodiment shown in FIG. 6A, each coupling element 80 can be connected to the support structure 6 by positioning each coupling element 80 in contact with the support structure 6 (in particular, on the top portion of said support structure 6) and by fastening it to the support structure 6 with fastening means (such as, for example, screws, bolts, rivets, or equivalent elements). However, the connection of each coupling element 80 to the support structure 6 may also be effected otherwise, a different way of mutual connection being shown by way of example in FIG. 6B and described below.

In accordance with a preferred embodiment, said coupling element 80 is shaped substantially like a horseshoe, i.e., it is substantially U-shaped, wherein the open tract of the horseshoe-shaped coupling element 80 faces towards the main shaft 51. This particular conformation of the coupling element 80 makes fastening it to and/or removing it from the support structure 6 easier, in particular because it is not necessary to act upon any other components of the sucker-removing device 1 according to the present invention; in this context, such provisions make it easier to replace each coupling element 80 for changing the type and/or shape and/or number and/or size of the protrusions 61 and the respective recesses 62 as required, particularly for the purpose of adapting the size of each protrusion 61 and each recess 62 to the size of the suckers to be removed and of the vegetable plant, without it being necessary to replace the whole cutting system 5.

In FIG. 6B it can be observed that the sucker-removing device 1 according to the present invention may also comprise at least one spacer element 90 adapted to position the coupling element 80 at different heights relative to the support structure 6 and relative to a respective disc 10, 20, 30, in particular said at least one spacer element 90 being removably fixed to the support structure 6; in particular, in FIG. 6B each coupling element 80 is shown to be positioned at a first height or distance from the support structure 6 (see the coupling elements 80 drawn with a continuous line in FIG. 6B) and at a different second height or distance from said support structure 6 (see the coupling elements 80 drawn with a dashed line in FIG. 6B).

Such provisions make it possible to mount the coupling element 80 (with the respective protrusions 61 and recesses 62) at a variable distance or height from the base of the vegetable plant, so that the trunk thereof can be approached as much as possible in order to remove all sucker residues close to the vegetable plant.

It must be pointed out that said at least one spacer element 90 may be fastened to the coupling element 80 in a removable manner, e.g., by using fastening means like screw, bolts, etc.

In the embodiment shown in FIG. 6B, said at least one spacer element 90 is constituted by a plurality of enclosures or cases matching the number of coupling elements 80 (and hence the number of discs 10, 20, 30) to be removably fastened to the support structure 6; in this context, each enclosure or case is so constructed as to enclose, between itself and the support structure 6, at least a portion of the transmission system 5T and/or at least a portion of the main shaft 51 and of the shafts 11, 21, 31 of the discs 10, 20, 30.

It should also be noted that, preferably, each coupling element 80 is fixed to a lateral wall 91 of the respective spacer element 90.

The features of the present invention, as well as the advantages thereof, are apparent from the above description.

In particular, the peculiar provisions of:
the support structure 6 coupled to said arm 2 in such a way as to rotate idle relative to a substantially vertical main axis of rotation 6A, and
the discs 10, 20, 30 carried by said support structure 6, make it possible to widen the area where suckers can be removed around said vegetable plant, permitting an effective and fast cutting of multiple suckers located on the diameter of the vegetable plant, in particular without requiring any specific movement of the arm 2 that carries the cutting system 5.

In fact, due to the provisions of the present invention, the positioning of each disc 10, 20, 30 relative to the vegetable plant is substantially automatic, in that such positioning is dictated by the contact between the plant and the support structure 6 and by the consequent idle rotation of the support structure 6, in particular said idle rotation being in turn induced and guided by such contact between the vegetable plant and the support structure 6.

Moreover, the positioning of the arm 2 (and hence of the support structure 6 and of the discs 10, 20) relative to the vegetable plant is dictated by the shock-absorbing device 8, which is so configured that the entire arm 2 can move along a horizontal plane when the support structure 6 touches the plant.

As a result, the provision of the shock-absorbing device 8 prevents the vegetable plant from suffering damage upon contacting the support structure 6; in fact, the shock-absorbing device 8 avoids the risk of jamming between the vegetable plant and the support structure 6, which jamming would otherwise inevitably damage the vegetable plant.

The sucker-removing device 1 according to the present invention is thus constructed in such a way that it does not require continual interventions by a user in order to properly position the arm 2 and the associated cutting system 5; as a result, the sucker-removing device 1 according to the present invention is so constructed as to reduce the attention required from the user during the sucker removal operations.

The sucker-removing device 1 according to the present invention makes it possible, therefore, to attain a high level of automation of the sucker removal operations and to increase the efficiency of such operations, in particular by reducing the time and resources necessary for the execution of such operations.

The provision of the protrusions 61 and the associated striker elements 61A facilitates said idle rotation of the support structure 6, in that such rotation occurs also as a result of the contact between the protrusions 61, possibly provided with associated striker elements 61A, and the vegetable plant. In addition to this, the protrusions 61 and/or the associated striker elements 61A avoid damage to the vegetable plant by preventing it from touching the discs 20, 30, and also mitigate possible impacts of the sucker-removing device 1 against said plant from which suckers have to be removed; moreover, said striker elements 61A turn out to be particularly effective in facilitating the entrance of the suckers into the recesses 62.

As to the provision of the retaining device 7, this is useful to prevent the idle rotation of the support structure 6 when the sucker-removing device 1 is not in contact with the vegetable plant, and to release the idle rotation of said support structure 6 when the sucker-removing device 1 is in contact (typically through the striker elements 61A) with the vegetable plant. In this regard, it must be highlighted that the retaining device 7 and the shock-absorbing device 8 co-operate to ensure an adequate positioning of the arm 2, of the support structure 6 and of the discs 10, 20, 30 both in the condition wherein the sucker-removing device 1 is in contact with the vegetable plant and in the condition wherein said sucker-removing device 1 is not in contact with the vegetable plant.

The peculiar provisions of the coupling elements 80 removably fastened to the support structure 6 permit changing the type and/or shape and/or number and/or size of the protrusions 61 and the respective recesses 62 as required, particularly for the purpose of adapting the size of each protrusion 61 and each recess 62 to the size of the suckers to be removed and of the vegetable plant, without it being necessary to replace the whole cutting system 5.

As concerns the provision of the spacer elements 90, they make it possible to mount each coupling element 80 (with the respective protrusions 61 and recesses 62) at a variable distance from the base of the vegetable plant, so that the trunk thereof can be approached as much as possible and all sucker residues close to the vegetable plant can be removed.

The sucker-removing device 1 and the associated agricultural machine 100 described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to the above-described sucker-removing device 1 and associated agricultural machine 100, but may be subject to many modifications, improvements or replacements of equivalent parts and elements without departing from the inventive idea, as clearly specified in the following claims.

1. An agricultural machine comprising a sucker-removing device adapted to remove suckers from a vegetable plant, said sucker-removing device comprising:
an arm extending substantially horizontal from the agricultural machine;
at least one actuator device;
a support structure extending substantially parallel to the arm, wherein said support structure is coupled to said arm by means of a main shaft extending along a substantially vertical main axis of rotation, at least one first bearing interposed between the main shaft and the arm, and at least one second bearing interposed between the main shaft and the support structure, such that the support structure can rotate idle relative to said substantially vertical main axis of rotation,
a cutting system comprising at least a first disc and a second disc, wherein the first disc is coupled to said support structure by means of a first shaft extending substantially perpendicular from the first disc along a first axis of rotation, and wherein the second disc is coupled to said support structure by means of a second shaft extending substantially perpendicular from the second disc along a second axis of rotation,
a transmission system connecting the actuator device to the main shaft and said main shaft to the first shaft of the first disc and to the second shaft of the second disc, wherein the first disc and the second disc are set in motion by said actuator device and by said transmission system so as to rotate about said first axis of rotation and, respectively, about said second axis of rotation, which are substantially parallel to said main axis of rotation, for the purpose of removing suckers from the vegetable plant.

2. The agricultural machine according to claim 1, wherein the first disc and the second disc face towards the support structure, in particular towards a lower portion of said support structure, and are positioned at substantially the same distance from said support structure.

3. The agricultural machine according to claim 1, wherein the first shaft of the first disc and the second shaft of the second disc are perpendicular to the extension of the arm and/or of the support structure and are substantially parallel to the main shaft.

4. The agricultural machine according to claim 1, wherein the support structure is, in a plan view, shaped as two circumferences in contact with each other, wherein the first shaft of the first disc and the second shaft of the second disc are positioned substantially at the centres of said two circumferences.

5. The agricultural machine according to one claim 1, wherein the main shaft is substantially equidistant from said first shaft and second shaft.

6. The agricultural machine according to claim 1, wherein the cutting system comprises a third disc coupled to said support structure by means of a third shaft extending substantially perpendicular from the third disc along a third axis of rotation which is substantially parallel to the main axis of rotation, wherein the third shaft and the third disc are set in motion by said actuator device and by said transmission system so as to rotate about a third axis of rotation which is substantially parallel to the main axis of rotation.

7. The agricultural machine according to claim 6, wherein the third disc faces towards the support structure, in particular towards a lower portion of said support structure, and is positioned at a given distance from said support structure, in particular the first disc, the second disc and the third disc being all positioned at the same distance from the support structure and being fixed to said support structure in such a way that they are substantially coplanar with one another.

8. The agricultural machine according to claim 6, wherein the support structure has, in a plan view, a perimeter substantially shaped as three circumferences in contact with one another, wherein the first shaft, the second shaft and the third shaft are positioned substantially at the centres of said three mutually contacting circumferences.

9. The agricultural machine according to claim 6, wherein the main shaft is substantially equidistant from said first shaft, second shaft and third shaft.

10. The agricultural machine according to claim 1, wherein the support structure comprises a plurality of protrusions spaced apart along an outer perimeter of said support structure so as to define a plurality of recesses between said protrusions, wherein each recess is adapted to receive a sucker to be cut,
wherein an assembly including said support structure and each protrusion extends along at least one plane perpendicular to each one of said axes of rotation by a quantity greater than the extension along the same perpendicular plane of each one of the discs,
and wherein each recess comprises a bottom which is distant from said axes of rotation by a quantity smaller than the extension of the respective discs along said perpendicular plane, so that said discs can come in contact with each sucker that enters said recesses and cut it.

11. The agricultural machine according to claim 10, wherein each protrusion comprises a striker element positioned in proximity to a distal end of the protrusion, in particular each striker element being associated with the respective protrusion in such a way as to rotate idle relative to said protrusion about an axis substantially parallel to the main axis of rotation.

12. The agricultural machine according to claim 10, wherein the sucker-removing device comprises a plurality of coupling elements removably fixed to the support structure, wherein the number of coupling elements matches the number of discs coupled to the support structure, and wherein each coupling element comprises a plurality of protrusions and respective recesses on its outer edge.

13. The agricultural machine according to claim 12, wherein each coupling element is shaped substantially like a horseshoe, wherein the open tract of the horseshoe-shaped coupling element faces towards the main shaft.

14. The agricultural machine according to claim 12, wherein the sucker-removing device comprises at least one spacer element adapted to position the coupling element at different heights relative to the support structure and relative to a respective disc, in particular said at least one spacer element being removably fixed to the support structure and/or said coupling element being removably fixed to the spacer element.

15. The agricultural machine according to claim 1, wherein it comprises a retaining device, in particular interposed between the arm and the support structure, adapted to stop or counter the idle rotation of the support structure when it is not in contact with the vegetable plant, and to release the idle rotation of said support structure when it is in contact with the vegetable plant.

16. The agricultural machine according to claim 15, wherein said retaining device comprises friction elements respectively positioned on the arm and on the support structure and in contact with each other, wherein said friction elements are configured to be positioned in contact with each other in order to counter the idle rotation of the support structure when it is not in contact with the vegetable plant, and to release the idle rotation of said support structure when it is in contact with the vegetable plant.

17. The agricultural machine according to claim 1, wherein it comprises a shock-absorbing device interposed between the arm and the agricultural machine and configured to allow the arm, the support structure and the discs to move along a horizontal plane when the support structure is in contact with the vegetable plant.

18. The agricultural machine according to claim 17, wherein said shock-absorbing device comprises:
four rods parallel to each other in pairs and hinged to each other in pairs, wherein a first rod of said four rods is fixed to the agricultural machine, and wherein said arm is fixed to a rod other than said first rod;
at least one return element which comprises a first portion or end fastened to a fixed point of the agricultural machine and a second portion or end fastened to a rod other than said first rod.

19. A sucker-removing device of an agricultural machine according to claim 1.
